(19) United States
(12) Patent Application Publication
(10) Pub. No.: US 2005/0019742 A1
(43) Pub. Date: Jan. 27, 2005

(54) Methods for assessment of platelet aggregation

(76) Inventors: Lisa K. Jennings, Memphis, TN (US); Melanie M. White, Memphis, TN (US)

Correspondence Address: Nixon Peabody LLP;Clinton Square, P.O. Box 31051, Rochester, NY, 14603-1051, US

(21) Appl. No.: 10/686,309

(22) Filed: Oct. 15, 2003

Related U.S. Application Data
(60) Provisional application No. 60/419,056, filed on Oct. 15, 2002.

(51) Int. Cl. A01N 1/00

(52) U.S. Cl. 435/1.1

(57) ABSTRACT

Methods for measuring platelet aggregation in a blood sample, for measuring the efficacy of anti-platelet therapies at the point of care, and for detecting the presence of platelet micro-aggregates in a blood sample. Several differences between the methods of the present invention and previously disclosed procedures for practicing such methods while using a hematology analyzer will allow for achieving about 0.98 correlation relative to light transmission aggregometry. These differences allow the methods of the present invention to be used at the point of care for assessing, e.g., the efficacy of anti-platelet therapy, particularly GPIIb-IIIa antagonists.

This application claims the priority benefit of U.S. Provisional Patent Application Ser. No. 60/419,056, filed Oct. 15, 2002, which is hereby incorporated by reference in its entirety.

### FIELD OF THE INVENTION

The present invention relates generally to assays or methods for measuring platelet aggregation in a blood sample, for measuring the efficacy of anti-platelet therapies at the point of care, and for detecting the presence of platelet micro-aggregates in a blood sample.

### BACKGROUND OF THE INVENTION

Platelets are small (approximately 2 μm-diameter), non-nucleated blood cells produced in the bone marrow from megakaryocytes. They are rapidly activated by blood vessel injury and are a crucial component of the primary hemostatic response. In their unactivated state, platelets are roughly discoid in shape and contain cytoplasmic organelles, cytoskeletal elements, invaginating open-canalicular membrane systems, and two types of platelet-specific granules called alpha granules and dense granules. Platelets also have numerous intrinsic glycoproteins attached to the outer surface of their plasma membrane that are receptors for such ligands as fibrinogen, collagen, thrombin, Thrombospondin, von Willebrand factor (“VWF”), and fibronectin.

Platelets promote hemostasis by the following interconnected mechanisms: adhering to sites of vascular injury or artificial surfaces, releasing compounds from their granules, aggregating together to form a hemostatic platelet plug, and providing a procoagulant surface for activated coagulation protein complexes on their phospholipid membranes. Platelet adhesion to subendothelium is the initial step in platelet activation. The subendothelium is composed of extracellular matrix proteins, many of which are ligands for receptors on the platelet surface. These adhesive proteins are exposed when the endothelial layer is disrupted. Due to the large number of extracellular matrix proteins and a high density of platelet surface receptors, platelets adhere rapidly to areas of vascular injury. VWF is a large, multimeric protein that is secreted into the extracellular matrix from endothelial cells and thereby facilitates platelet adhesion by binding to platelet surface glycoprotein Ib/IX/V. Platelets can also adhere to vascular wall-associated fibrin or fibrinogen via surface glycoprotein Ib/IIIa (“GPIIb-IIIa”).

After adhering to the subendothelium, platelets undergo cytoskeletal activation, which leads to a change in their shape and the development of pseudopods. Intracellular signaling processes leading to increased cytoplasmic calcium then initiate a secretory release reaction that releases products from the alpha granules and from the dense granules. Products released from the alpha granules include platelet factor 4, β-thromboglobulin, thrombospondin, platelet-derived growth factor, fibrinogen, and VWF. Products released from the dense granules include adenosine diphosphate (“ADP”) and serotonin. The release of ADP combined with calcium mobilization leads to a conformational change of the fibrinogen receptor, the GPIIb-IIa receptor complex (integrin α_{IIb}β₃). This initiates the process of aggregation, in which a GPIIb-IIIa receptor on one platelet is bound in a homotypic fashion to the same receptor on adjacent platelets via a central fibrinogen or VWF molecular bridge. Beside ADP, other agonists, such as epinephrine, thrombin, collagen, and platelet-activating factor, can initiate platelet aggregation by interacting with membrane receptors. This platelet-release reaction and aggregation recruit many other platelets to the vessel wall and forms a platelet thrombus or hemostatic plug.

Activated platelets also play a vital procoagulant role that serves as a link between platelet function and coagulation activation. Platelet membrane phospholipids are rearranged during activation, and phosphatidyl serine is transferred from the inner table to the outer table of the platelet membrane, providing a binding site for phospholipid-dependent coagulation complexes that activate factor X and prothrombin.

In certain circumstances, it is desirable to assess the degree of platelet aggregation in whole blood or platelet-rich plasma. These circumstances include diagnosing patients for platelet activation or aggregation disorders as well as assessing the efficacy of anti-platelet therapy. Anti-platelet thereapy is standard of care for patients as an adjunct to percutaneous coronary intervention (“PCI”) or for medical management of non-ST elevation acute coronary syndromes (“NSTE ACS”).

Inhibition of platelet aggregation via platelet GPIIb-IIIa receptor antagonists has demonstrated a significant clinical benefit as an adjunct in PCI and for the treatment of NSTE ACS (Kandzari and Califf, “TARGET versus GUSTO-IV: Appropriate Use of Glycoprotein IIb/IIIa Inhibitors in Acute Coronary Syndromes and Percutaneous Coronary Intervention,” Curr. Opin. Cardiol. 17:332-339 (2002). The platelet GPIIb-IIIa receptor antagonists eptifibatide, tirofiban and abciximab effectively block the binding of fibrinogen and von Willebrand factor to the activated GPIIb-IIIa complex on platelets. Inhibition of ligand binding effectively blocks the formation of the platelet thrombus.

In the clinical setting, little data are available that demonstrate the required level of platelet aggregation inhibition necessary for reduction of major adverse cardiac events (MACE). In an animal model study, light transmission aggregometry assays indicated that platelet aggregation was inhibited profoundly and acute thrombosis was prevented when >80% of the receptors were blocked (Gold et al., “Rapid and Sustained Coronary Artery Recanilization with Combined Bolus Injection of Recombinant Tissue-type Plasminogen Activator and Monoclonal Antiplatelet GPIIb/IIIa Antibody in a Canine Preparation,” Circulation 77:670-677 (1988)). Data from the EPIC trial using abciximab suggested that sustained >80% blockade of GPIIb-IIIa receptors was necessary to achieve significant benefit (The EPIC Investigators, “Use of a Monoclonal Antibody Directed Against the Platelet Glycoprotein IIb/IIIa Receptor in High-risk Coronary Angioplasty,” N. Engl. J. Med. 330:956-961 (1994)). In addition, data from the recent Gold trial showed that PCI patients who had >95% platelet inhibition, as measured using the Accumetrics Ultegra® instrument at 10 minutes following initiation of drug infusion, had significantly reduced rates of MACE compared to patients with lower levels of inhibition (Steinhubl et al., “Point-of-Care Measured Platelet Inhibition Correlates with a Reduced Risk of an Adverse Cardiac Event After Percutaneous Coronary Intervention,” Circulation 103:2572-2578 (2001)).

These data support the need for a rapid and simple assay to assess the levels of platelet inhibition or receptor blockade that is useful for monitoring anti-platelet therapy or guiding dose adjustments. Thus far, the most accurate monitoring tests available include LTA and receptor occupancy, both of which require time, technical expertise and specialized reagents (Jennings and White, “Expression of Ligand-induced Binding Sites on Glycoprotein IIb/IIIa Complexes and the Effect of Various Inhibitors,” Am. Heart J. 135:S179-83 (1998)).

More recently, two point-of-care devices have been evaluated, the Ultegra® rapid platelet function assay (“RPFA”) (Accumetrics, San Diego, Calif.) and the ICHOR/Plateletworks® (Helena Laboratories, Beaumont, Tex.).

The RPFA using the Accumetrics Ultegra® is an automated turbidimetric whole blood assay designed to assess platelet aggregation based on the ability of activated platelets to bind fibrinogen. Fibrinogen-coated polystyrene microparticles agglutinate in whole blood in proportion to the number of available platelet GPIIb-IIIa receptors. The Ultegra® specifically is designed to measure the effect of GPIIb-IIIa antagonist-drugs, such as abciximab, tirofiban, or eptifibatide. Using the agonist iso-TRAP, it is not sensitive to such drugs as aspirin, clopidogrel, or ticlopidine, and it is not designed to detect platelet function disorders or von Willebrand disease.

Plateletworks® is used with the ICHOR hematology analyzer and is designed to determine the percentage of platelet aggregation in fresh whole blood samples taken during interventional cardiac procedures. Using electrical impedance, it measures the change in the platelet count due to aggregation of functional platelets in the blood sample. It is the first bedside test to simultaneously measure platelet count and platelet aggregation.

While initially showing promise, the Ultegra® instrument has not proven to be sufficiently accurate for monitoring anti-GPIIb-IIIa therapy in the critical dosing range. For example, the results reported by Kereiakes et al. (“Time Course, Magnitude and Consistency of Platelet Inhibition by Abciximab, Tirofiban, or Eptifibatide in Patients with Unstable Angina Pectoris Undergoing Percutaneous Coronary Intervention,” Am. J. Cardiol. 84:391-395 (1999)) suggest that values obtained by the Ultegra® overestimated the level of platelet inhibition and did not mirror LTA results. Simon et al. (“A Comparative Study of Light Transmission Aggregometry and Automated Bedside Platelet Function Assay in Patients Undergoing Percutaneous Coronary Intervention and Receiving Abciximab, Eptifibatide, or Tirofiban,” Cathet. and Cardiovasc. Intervent. 52:425-432 (2001)) compared standard LTA and two bedside platelet function assays, the Ultegra® and Xylum Clot Signature Analyzer®. Their results showed that Ultegra® measurements were similar to that obtained with LTA for abciximab, but overestimated platelet inhibition achieved by the small molecules, eptifibatide and tirofiban. Another study using the anticoagulant sodium citrate, previously shown to overestimate GPIIb-IIIa antagonist effects (Phillips et al., “Effect of Ca⁺⁺ on Integrilin™ GPIIb-IIIa Interactions: Enhanced GPIIb-IIIa Binding and Inhibition of Platelet Aggregation by Reductions in the Concentration of Ionized Calcium in Plasma Anticoagulated with Citrate,” Circulation 96:1488-1494 (1997); Nannizzi-Alaimo et al., “Effect of Citrate Anticoagulation and Platelet Agonist Concentration on the Inhibitory Activities of GPIIb-IIIa Antagonists,” Circulation 100:1710 (1999); Kereiakes et al., “Differential Effects of Citrate Versus PPACK Anticoagulation on Measured Platelet Inhibition by Abciximab, Eptifibatide and Tirofiban,” J. Thromb. Thrombolysis 12:123-127 (2001); Jennings et al., “The Pharmacodynamics of Parenteral Glycoprotein IIb/IIIa Inhibitors,” J. Interv. Cardiol. 15(1)-45-60 (2002)), showed high correlations of Ultegra® results with LTA slope (rate of aggregation); however, data comparing Ultegra® results and inhibition of LTA extent of aggregation response were not reported (Wheeler et al., “The Ultegra Rapid Platelet-Function Assay: Comparison to Standard Platelet Function Assays in Patients Undergoing Percutaneous Coronary Intervention With Abciximab Therapy,” Am. Heart J. 143:602-611 (2002)).

In regard to the Plateletworks®/ICHOR system, Lakkis et al. showed a correlation (r=0.83) when comparing platelet aggregation results using Plateletworks® with LTA in 225 paired samples (“Use of ICHOR-Platelet Works to Assess Platelet Function in Patients Treated With GP IIb/IIIa Inhibitors,” Cathet. Cardiovasc. Intervent. 53:346-351 (2001)). In addition, a small ACS patient cohort receiving either abciximab or tirofiban was evaluated for platelet aggregation inhibition using Plateletworks® and results confirmed previously reported levels of platelet inhibition achieved with these two agents.

The increased use of GPIIb-IIIa antagonists has mandated the development of standardized methods to assess platelet inhibition and predict subsequent efficacy as a result of treatment. Furthermore, recent data suggest that high levels of platelet function inhibition by GPIIb-IIIa antagonists also reduce the release of pro-inflammatory mediators such as platelet soluble CD40L that may promote coagulation and facilitate high shear platelet thrombus formation (Nannizzi-Alaimo et al., “GPIIb-IIIa Antagonists Demonstrate a Dose-dependent Inhibition and Potentiation of Soluble CD40L (CD 154) Release During Platelet Stimulation,” Circulation 104(suppl II):II-318, Abst. 1533 (2001); Andre et al., “Platelet-Derived CD40L: The Switch-Hitting Player of Cardiovascular Disease,” Circulation 106:896-899 (2002)). Thus, the extent of platelet GPIIb-IIIa receptor blockade may not only affect acute platelet thrombus formation but also modulate vascular inflammatory response. For these reasons, confirmation of the levels of platelet aggregation inhibition becomes increasingly important.

Several approaches to monitoring platelet function inhibition or receptor blockade have been reported including inhibition of platelet aggregation measured by traditional light transmission aggregometry, whole blood point of care platelet function assays such as the Ultegra®, the Platelet Function Analyzer (PFA-100), the Xylum Clot Signature Analyzer (CSA), the Plateletworks® rapid platelet aggregometer used with the ICHOR hematology analyzer, and receptor occupancy assays using the D3 monoclonal antibody (Jennings and White, “Expression of Ligand-induced Binding Sites on Glycoprotein IIb/IIIa Complexes and the Effect of Various Inhibitors,” Am. Heart J. 135:S179-83 (1998); Simon et al., “A Comparative Study of Light Transmission Aggregometry and Automated Bedside Platelet Function Assay in Patients Undergoing Percutaneous Coronary Intervention and Receiving Abciximab, Eptifibatide, or Tirofiban,” Cathet. and Cardiovasc. Intervent. 52:425-432 (2001)).

Further improvements to existing platelet aggregation assays are needed to ensure greater accuracy of point of care measurements used for delivery and monitoring of anti-platelet therapies. The present invention is intended to overcome these and other deficiencies in the art.

### SUMMARY OF THE INVENTION

A first aspect of the present invention relates to a method of measuring platelet aggregation in a blood sample. This method of the invention includes: obtaining a blood sample from an individual; exposing the blood sample immediately to an anticoagulant; treating the anticoagulated blood sample with an agonist of platelet aggregation; and analyzing the treated blood sample with an automated hematology analyzer to determine the degree of platelet aggregation in the treated blood sample, wherein said analyzing is carried out prior to the occurrence of substantial disaggregation.

A second aspect of the present invention relates to a method of determining or monitoring the efficacy of anti-platelet therapy. This method of the invention includes: obtaining a blood sample from an individual treated with an anti-platelet therapy; exposing the blood sample immediately to an anticoagulant; treating the anticoagulated blood sample with an agonist of platelet aggregation; and analyzing the treated blood sample with an automated hematology analyzer to determine the level of platelet aggregation inhibition in the treated blood sample, wherein platelet count at or above a baseline level indicates that the anti-platelet therapy is less than effective and wherein said analyzing is carried out prior to the occurrence of substantial disaggregation.

A third aspect of the present invention relates to a method of detecting the presence of platelet micro-aggregates in a blood sample. This method of the invention includes: obtaining a blood sample from an individual; exposing the blood sample immediately to an anticoagulant; treating the anticoagulated blood sample with an agonist of platelet aggregation; and analyzing the treated blood sample with an automated hematology analyzer, wherein an MPV substantially greater than measured at baseline indicates the presence of platelet aggregates in the test sample and indicative of incomplete inhibition of platelet aggregation.

The present invention involves the identification of several improvements of previously recommended procedures. One of these improvements relates to the need to utilize the same anticoagulant with the baseline procedure and the test procedure. While Helena suggests using an EDTA baseline and citrate test sample, applicants have identified PPACK as a preferred anticoagulant for both baseline and test procedures. Another improvement relates to the amount of anticoagulant utilized in collecting blood samples. Lower concentrations of PPACK are acceptable if the sample is analyzed substantially immediately as outlined; however, when analysis is delayed (>20 min) a higher concentration of PPACK is required. A final improvement of the invention concerns the timing of aggregation measurements. When testing samples in which platelet aggregation is minimally inhibited and reversible aggregation occurs, waiting to count samples for more than about 5 minutes after introduction of agonist will result in disaggregation of platelets, a falsely elevated platelet count, and an underestimation of inhibition of platelet aggregation. The longer the delay, the greater the extent of disaggregation.

The sample to be measured should always be run substantially immediately after exposure to agonist (assay time predicted to be 2-3 minutes). If the sample is drawn into a tube containing agonist it is to be analyzed first, saving the baseline tube until the last agonist-exposed sample is analyzed. By virtue of practicing the present invention, the extent of aggregation can be measured with a high degree of accuracy (relative to LTA) and without the delays that normally result during LTA, allowing for reliable detection at the point of care and better management of on-going anti-platelet therapies during and/or following PCI or NSTE ACS.

### BRIEF DESCRIPTION OF THE DRAWINGS

FIG. 1 is a graph illustrating the percent inhibition of platelet aggregation, as assessed by Plateletworks®, using three different types of baseline platelet counts. “EDTA” baseline refers to calculations based on platelet counts using the EDTA collection tube provided with Plateletworks®. “PPACK” baseline refers to calculations based on platelet counts measured in 300 μM D-Phe-Pro-Arg chloromethyl ketone dihydrochloride. “Max” refers to calculations based on platelet counts from a tube containing saturating concentrations of antagonist, representing 0% aggregation. (N=10, ±SD).

FIG. 2 is a graph illustrating the comparison of platelet inhibition using light transmission aggregometry, Ultegra® and Plateletworks® measurements in the presence of increasing concentrations of the antagonist eptifibatide using PPACK anticoagulant (N=5, ±SEM).

FIG. 3 is a graph illustrating the comparison of platelet inhibition using light transmission aggregometry, Ultegra® and Plateletworks® measurements in the presence of increasing concentrations of the antagonist tirofiban using PPACK anticoagulant (N=5, ±SEM).

FIG. 4 is a graph showing the composite correlation of platelet inhibition by eptifibatide and tirofiban using light transmission aggregometry versus Ultegra® and Plateletworks®.

### DETAILED DESCRIPTION OF THE INVENTION

The present invention relates to the measuring platelet aggregation in a blood sample, preferably for purposes of determining or monitoring the efficacy of anti-platelet therapy, or determining the presence of microaggregates in a blood sample.

As used herein, “individual” or “patient” refers to any individual whose platelets possess a GPIIb-IIIa receptor. Preferred individuals are mammals. Exemplary mammals include, without limitation, primates such as humans, chimpanzees, orangutans, monkeys, etc., dogs, cats, horses, cows, and pigs.

Blood is obtained from an individual in any conventional manner, preferably but not exclusively by venipuncture. Alternatively, to the extent that blood is collected during a medically invasive procedure, such as open heart surgical procedures, blood can be drawn from any medical equipment responsible for circulating blood during such procedures, such as a heart-lung machine.

Upon obtaining a blood sample from an individual, the drawn blood is preferably exposed immediately to an anticoagulant to preclude coagulation thereof. Known anticoagulants include heparin, EDTA, D-Phe-Pro-Arg chloromethyl ketone dihydrochloride (“PPACK”), and sodium citrate. Of these, PPACK is preferred for use with GPIIb-IIIa receptor antagonists.

A number of antagonists of platelet aggregation are known in the art. Preferred antagonists for use in the accordance with the present invention are GPIIb-IIIa receptor antagonists. Exemplary GPIIb-IIIa receptor antagonists include, without limitation, abciximab, eptifibatide, and tirofiban.

A number of agonists are available for inducing platelet aggregation. Suitable agonists include, without limitation, adenosine diphosphate (“ADP”), epinephrine, thrombin or TRAP, collagen, and platelet-activating factor. Of these, ADP is preferred.

Analysis of blood samples can be carried out using any hematology analyzer, preferably an automated hematology analyzer. One preferred automated hematology analyzer is an electrical impedance-type hematology analyzer known as the ICHOR hematology analyzer, which is available from Helena Laboratories. The ICHOR device is a point of care hematology analyzer that identifies platelet aggregation as a result of changes in the platelet count. The hematology analyzer is equipped with adjustable threshold levels for discriminating platelet aggregates from other cellular bodies in the blood sample.

In carrying out the methods of the present invention, the method of measuring platelet aggregation in a blood sample is carried out by obtaining a blood sample from an individual, exposing the blood sample immediately to an anticoagulant, treating the anti-coagulated blood sample with an agonist of platelet aggregation, and then analyzing the treated blood sample with the hematology analyzer to determine the degree of platelet aggregation in the treated blood sample. Prior to analyzing the blood sample it is preferably mixed thoroughly by any available means, such as by repeated inversion of the vessel in which the sample is contained. Pre-existing aggregates can be identified provided that a baseline tube containing single platelets is provided.

As identified above, applicants have surprisingly identified the occurrence of disaggregation over the course of time between the step of treating and the step of analyzing. To avoid inaccurate results which occur as a result of disaggregation, the step of analyzing the blood sample should occur prior to the occurrence of substantial disaggregation. Applicants have identified that substantial disaggregation can occur in 5 minutes after treating the blood sample with the agonist. Therefore, the step of analyzing is preferably carried out within less than 5 minutes after the step of treating with agonist, preferably less than about 3 minutes after said treating, and more preferably substantially immediately after said treating (i.e., within about 30 seconds).

As demonstrated in the examples, infra, measurement of platelet aggregation can be achieved reliably and with a high degree of accuracy. A strong correlation was seen with the results obtained in the present invention relative to the results obtained when practicing LTA. As a result of the present invention, the correlation with measurements of aggregation using LTA are r²≧0.85, more preferably r²≧0.90, even more preferably r²≧0.925. Most preferred embodiments can achieve a correlation of r²≧0.95 or greater. The strong correlation indicates that the present invention is ideally suited for assessing platelet aggregation for purposes of monitoring the efficacy of anti-platelet therapy at the point of care, thereby allowing medical staff to adjust the dosage or the particular course of anti-platelet therapy with much greater accuracy that that previously afforded.

This aspect of the present invention is carried out by obtaining a blood sample from an individual treated with an anti-platelet therapy, exposing the blood sample immediately to an anticoagulant, and analyzing the treated blood sample with an automated hematology analyzer to determine the level of platelet aggregation inhibition in the treated blood sample. If platelet count is at or above a baseline level, then the anti-platelet therapy is in effective (and modification in the therapy is warranted, at the discretion of the medical staff). Unlike other methods, the baseline can be attained either prior to or during administration of anti-platelet therapy.

Whether a baseline measurement or a subsequent measurement of platelet aggregation inhibition, it is preferable that the anticoagulant used in determining the baseline level is the same anticoagulant used in all subsequent measurements.

As with the other measurements described in relation to the first aspect of the present invention, mixing of the anticoagulated blood sample prior to analyzing for aggregation inhibition is preferred.

In yet another aspect of the present invention, adjustment of the hematology analyzer threshold can be used to discriminate platelet aggregates from microaggregates. As a result, the present invention also affords a method of detecting the presence of platelet micro-aggregates in a blood sample. This method involves obtaining a blood sample from an individual, exposing the blood sample immediately to an anticoagulant, treating the anticoagulated blood sample with an agonist of platelet aggregation, and then analyzing the treated blood sample with an automated hematology analyzer, wherein an MPV substantially greater than measured at baseline indicates the presence of platelet aggregates in the test sample and indicative of incomplete inhibition of platelet aggregation. By substantially greater, it is intended the MPV value increases to a statistically significant extent; preferably by at least 2-fold, more preferably at least by 5-fold.

As with the other measurements described in relation to the first and second aspects of the present invention, mixing of the anticoagulated blood sample prior to analyzing for microaggregates is preferred and analyzing the sample prior to the occurrence of substantial disaggregation is likewise preferred. In assessing the level of microaggregates, it is possible to also obtain baseline measurements as described above.

### EXAMPLES

The Examples set forth below are for illustrative purposes only and are not intended to limit, in any way, the scope of the present invention.

Materials and Methods

A Payton Scientific dual channel lumi-aggregation module (Payton Scientific, Buffalo, N.Y.) was used for all light transmission aggregation testing. For assessment of whole blood platelet aggregation, a Helena Laboratories ICHOR hematology analyzer (Helena Laboratories, Beaumont, Tex.) and Plateletworks® were used. For assessment of whole blood platelet function inhibition the Accumetrics Ultegra® device (Accumetrics, Inc, San Diego, Calif.) was used. Adenosine 5′-Diphosphate (“ADP”) was obtained from Sigma Chemical Company (St. Louis Mo.). D-Phe-Pro-Arg chloromethyl ketone dihydrochloride (“PPACK”) was purchased from CalBiochem (La Jolla, Calif.). PPACK Vacuette tubes were obtained from Greiner BioOne (Monroe, N.C.). EDTA tubes were obtained from Helena Laboratories. Eptifibatide was provided by COR Therapeutics (South San Francisco, Calif.) and tirofiban was obtained from Merck (West Point, Pa.). Blood was collected from healthy normal donors following written informed consent.

Sufficient blood volume was collected to complete matched comparisons for each donor in all three assays. Using a 19 g butterfly needle, blood was collected by venipuncture into a plastic syringe and transferred to a tube containing PPACK anticoagulant (0.3 mM final concentration) or into PPACK vacuettes provided by Ultegra®. An EDTA baseline tube was also drawn per Plateletworks® recommendation. One 10 mL sample of PPACK blood was centrifuged at 135 g for 15 minutes to obtain platelet rich plasma (“PRP”) for use in traditional light transmission aggregometry. The residual blood from this tube was centrifuged at 1500 g for 15 minutes to obtain platelet poor plasma (“PPP”). PRP was diluted to 250,000/mm³ with autologous PPP. Diluted PRP (0.5 ml) was added to an aggregation cuvette and placed into the 37° C. aggregation chamber. Eptifibatide (125-4000 nM) or tirofiban (25-200 nM) was added to PRP, incubated for at least two minutes. 50 μl ADP (20 μM final concentration) was added to 0.45 ml PRP and the aggregation response was recorded. A baseline aggregation response (no antagonist present) was determined for each donor.

Percent aggregation was calculated at the point of maximum light transmission obtained within five minutes. Percent inhibition of aggregation (IPA) was calculated using the following formula:

$$\frac{( \% baseline aggregation - \% aggregation post \text{-} treatment )}{\% baseline aggregation} \times 100 = \% IPA$$

Whole blood platelet aggregation was performed using a procedure modified from that outlined in the Helena Plateletworks® brochure. PPACK anticoagulant was used instead of citrate due to the well-documented effect of citrate overestimating the level of platelet inhibition by all currently approved GPIIb-IIIa antagonists (Phillips et al., “Effect of Ca⁺⁺ on Integrilin™ GPIIb-IIIa Interactions: Enhanced GPIIb-IIIa Binding and Inhibition of Platelet Aggregation by Reductions in the Concentration of Ionized Calcium in Plasma Anticoagulated with Citrate,” Circulation 96:1488-1494 (1997); Nannizzi-Alaimo et al., “Effect of Citrate Anticoagulation and Platelet Agonist Concentration on the Inhibitory Activities of GPIIb-IIIa Antagonists,” Circulation 100:1710 (1999); Kereiakes et al., “Differential Effects of Citrate Versus PPACK Anticoagulation on Measured Platelet Inhibition by Abciximab, Eptifibatide and Tirofiban,” J. Thromb. Thrombolysis 12:123-127 (2001); Jennings et al., “The Pharmacodynamics of Parenteral Glycoprotein IIb/IIIa Inhibitors,” J. Interv. Cardiol. 15(1):45-60 (2002), each of which is hereby incorporated by reference in its entirety). For this assay, 1.0 ml of PPACK anticoagulated whole-blood was mixed with increasing concentrations of eptifibatide or tirofiban and incubated for at least 2 minutes. After addition of ADP (20 μM), the tube was inverted 15-20 times to ensure mixing, and the platelet count was performed immediately (test sample). A baseline tube was also drawn and handled exactly as the antagonist sample tube minus the addition of agonist. A platelet count was also performed on blood collected into EDTA per the manufacturer's instructions. Percent inhibition of platelet aggregation was obtained from the platelet inhibition/aggregation calculation wheel provided with Plateletworks®.

Whole blood rapid platelet function assays were performed using the procedure recommended by the Ultegra® manufacturer. Briefly, 2.0 ml of whole blood collected into a PPACK Vacuette tube was mixed with increasing concentrations of eptifibatide or tirofiban and incubated for at least 2 minutes. The tube was then inserted into the cartridge of the Ultegra® device which contains a modified thrombin receptor activating peptide (iso-TRAP), and the rate of agglutination with fibrinogen coated beads was measured as a change in absorbance over a fixed time interval. The device then reported this rate as platelet aggregation units (PAUs). Percent inhibition of platelet function was reported by the instrument, using stored baseline sample values obtained by assaying a sample containing no antagonist.

### Example 1

### Assessment of Platelet Aggregation Using LTA, Ultegra-RPFA, and Helena ICHOR/Plateletworks® Equipment

The Helena Plateletworks® assay is based on the measured difference in the number of single platelets in the agonist treated test sample compared to the baseline control sample. Thus it is important to establish the appropriate method for obtaining the baseline sample count in order to accurately determine the degree of platelet inhibition induced by anti-platelet therapy.

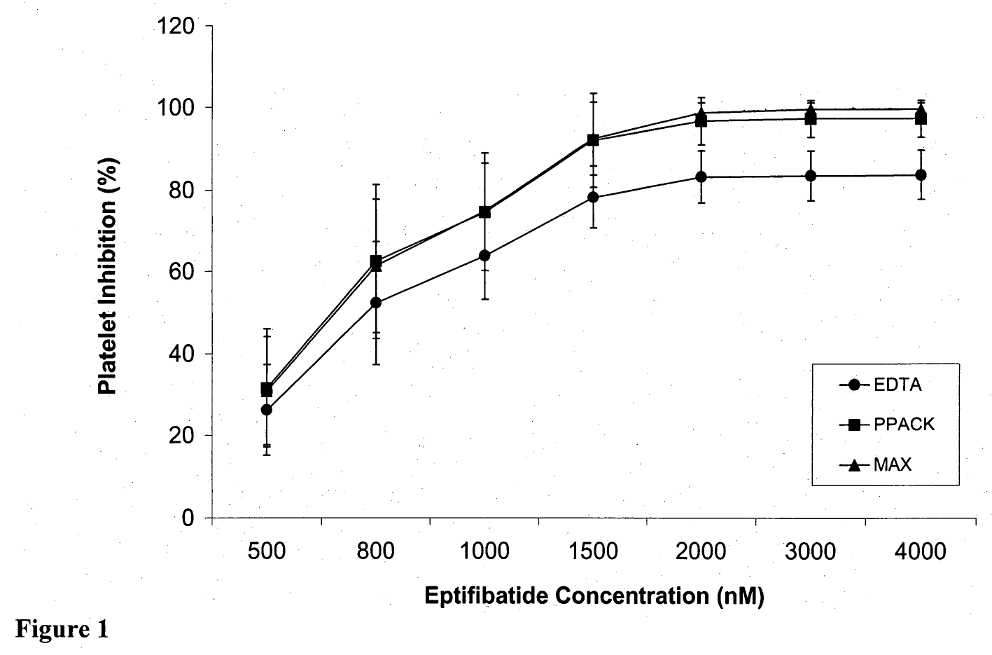

The percent inhibition of platelet aggregation using the Helena Plateletworks® was calculated using three different “baseline” sample platelet counts that represented “0%” inhibition of aggregation. The results are shown in FIG. 1. “EDTA” baseline refers to calculations based on the platelet count obtained from the EDTA baseline collection tube provided in the Plateletworks® package. “PPACK” baseline platelet counts were measured in blood drawn into a tube containing 0.3 mM final concentration PPACK and handled exactly as an antagonist treated tube. The third baseline count labeled as “Max” was measured using the count obtained from blood drawn into a PPACK anticoagulant tube and treated with a saturating concentration of antagonist. This latter sample should reflect 100% inhibition of platelet aggregation and should match the platelet count of the PPACK baseline untreated sample. As can be seen in FIG. 1, the PPACK and Max baseline results were virtually identical. However, the baseline EDTA platelet count was always higher than either the baseline PPACK platelet count or the “Max” platelet count. A higher platelet count in the baseline tube results in an overestimation of platelet aggregation response (and consequently an underestimation of platelet inhibition) in test samples. These results clearly indicate that in using the Plateletworks® to assess the inhibition of platelet function caused by a platelet antagonist, it is necessary to use a baseline tube drawn into the same anticoagulant as the test sample. Due to the fact that anticoagulant choice is critical for the pharmacodynamic evaluation of GPIIb-IIIa antagonists, PPACK anticoagulant was used for measuring platelet function in the point of care devices as well as for the LTA.

Due to the potential utility of the Plateletworks® as a point of care device, the methodology used to accurately measure platelet inhibition in the presence of GPIIb-IIIa antagonists was further defined as discussed below.

First, although Plateletworks® ADP/citrate method is stable for up to 20 minutes after ADP exposure, the ADP/PPACK method for the evaluation of GPIIb-IIIa antagonists must be performed within 5 minutes. In this study it was found that platelet counts in the test samples containing lower doses of eptifibatide or tirofiban started to increase after 5 minutes due to disaggregation. This tendency to disaggregate was also seen in the LTA assay run simultaneously with the Plateletworks® and leads to a measured decrease in the percent aggregation. In these studies, complete disaggregation (as reflected by increasing platelet counts in the same sample repeated over time) often occurred within the 20 minute time interval allowed in the Plateletworks® instructions. This measurement artifact would lead to the erroneous conclusion that no inhibition of aggregation had occurred.

Second, Plateletworks® also states that blood should be drawn directly into the aggregation tubes that contain both anticoagulant and agonist. We found that collecting blood into PPACK and then transferring a set volume to a tube to which ADP was added allowed the flexibility of analysis time without the risk of inaccurate results. It also allowed for duplicate runs of a specimen if questionable results were initially obtained. This modification in the outlined procedure still maintains an operator-friendly methodology with rapid assessment of platelet function inhibition. Utilizing these minor modifications in methodology, we compared platelet inhibition levels of the Plateletworks® with that of Ultegra® and standard LTA. Both eptifibatide and tirofiban were used in evaluations.

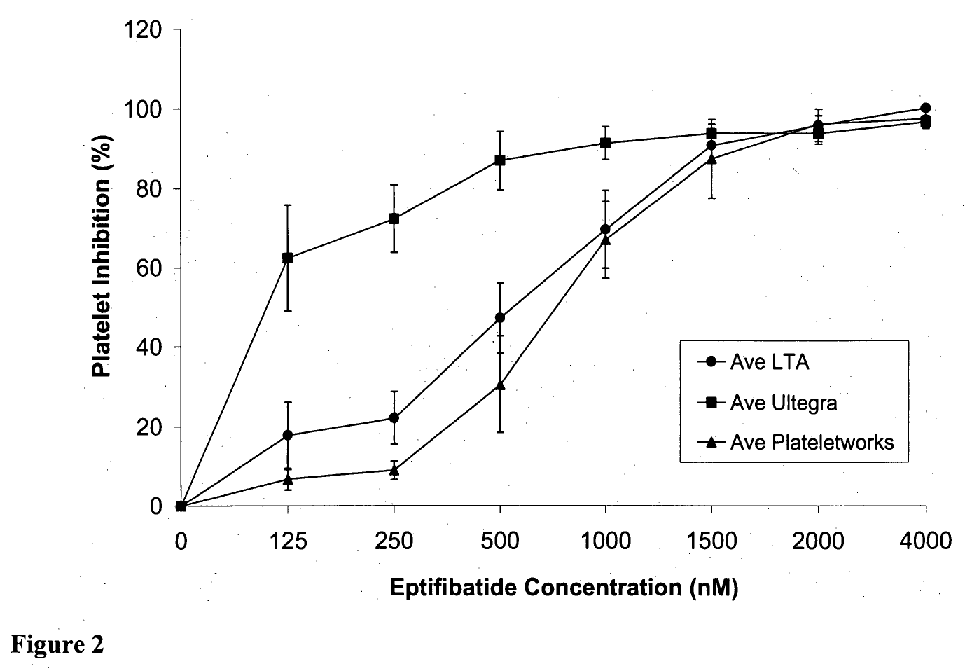

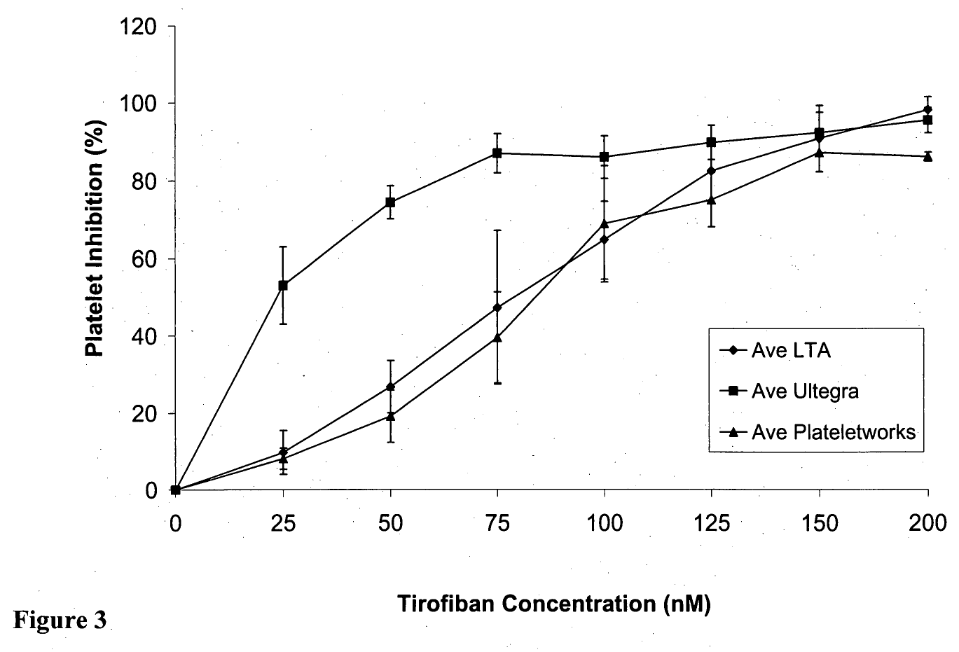

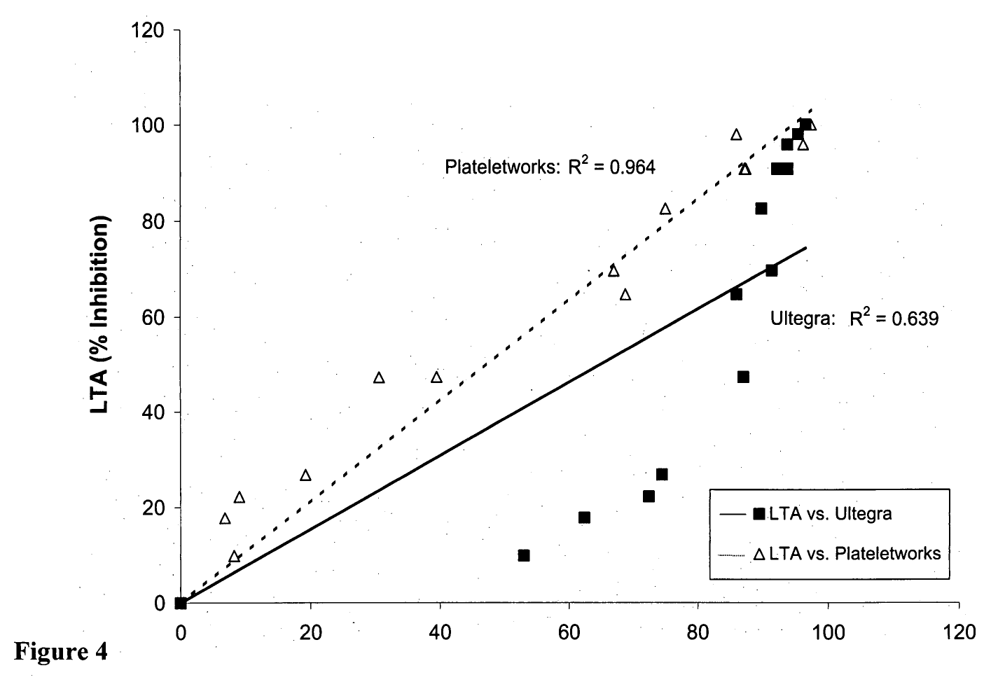

To compare the point of care devices with light transmission aggregometry, percent LTA and percent IPA were calculated using the data obtained from the Payton aggregometer. FIG. 2 reports the platelet inhibition data obtained using LTA in comparison to data from the Plateletworks® or Ultegra® instruments using PPACK anticoagulant in both baseline and test sample tubes and the antagonist eptifibatide. The same subjects were used for the comparative analyses that were run simultaneously. The results from the LTA and Plateletworks® assays mirrored each other and had a correlation coefficient (r²) of 0.980, a result superior to that observed when comparing the LTA results with the Ultegra® (r²=0.663). The data in FIG. 2 show that the Ultegra® overestimates levels of platelet inhibition when compared to LTA and ICHOR. These results show that platelet inhibition of 80% or greater measured by Ultegra® may represent inhibition ranging from an average of 30% to greater than 80% when measured by the ICHOR or the accepted standard LTA. These data are confirmed in FIG. 3, which shows data obtained using a second GPIIb-IIIa antagonist, tirofiban. Once again, the LTA and Plateletworks® results mirrored each other (r²=0.982) compared to the LTA versus Ultegra® (r²=0.686). Measured inhibition by tirofiban of 80% or greater on the Ultegra® may range from an average of 35% to greater than 80% on LTA or Plateletworks®. Interestingly, as predicted by the Gold study, Ultegra® inhibition levels for both eptifibatide and tirofiban of greater than 90% must be achieved to accurately serve as a surrogate for LTA or ICHOR. FIG. 4 is a composite representation of the combined eptifibatide and tirofiban LTA data compared to the Plateletworks® (r²=0.964) and the Ultegra® (r²=0.639). These data, when combined, demonstrate the discrepancy in levels of inhibition by the Ultegra® compared to the other two methods. Ultegra® values less than 90% may grossly overestimate actual platelet inhibition levels. The inability of the Ultegra® to provide an adequate dose response read-out is not readily apparent.

The purpose of this Example was to evaluate the Plateletworks® compared to Ultegra® and LTA in the assessment of platelet function inhibition by GPIIb-IIIa antagonists. To assess platelet aggregation inhibition using the Plateletworks®, it was necessary to redefine the experimental conditions such that the read-out accurately reflected platelet aggregation inhibition. Surprisingly and in contrast to the current recommendations made by the manufacturer, baseline counts performed in EDTA were unacceptable and resulted in an underestimation of the level of platelet inhibition caused by anti-platelet therapies. Using the EDTA baseline platelet count for calculation of % IPA resulted in a failure to achieve 100% inhibition of platelet aggregation even in the presence of greater than saturating concentrations of GPIIb-IIIa antagonists.

When PPACK anticoagulant was used for a baseline sample, the results obtained in the Plateletworks® assay mirrored that found by LTA. Thus, PPACK must be used when drawing the baseline sample rather than EDTA when platelet function testing is performed. In addition, when using PPACK it was absolutely necessary to measure the platelet aggregation level within 5 min of exposure to ADP, as longer timepoints demonstrated dissociation of the aggregates leading to an underestimation of anti-platelet therapy effect. Measurements made more than 5 min after exposure to the ADP agonist will not necessarily reflect the level of platelet inhibition. Furthermore, modification of this assay to permit flexibility regarding when ADP exposure takes place will extend the window for completion of the assay.

This study demonstrated that under defined conditions the aggregation inhibition results using Plateletworks® had a high correlation to results obtained with the gold standard LTA. Correlation was higher than that previously reported (Wheeler et al., “The Ultegra Rapid Platelet-Function Assay: Comparison to Standard Platelet Function Assays in Patients Undergoing Percutaneous Coronary Intervention With Abciximab Therapy,” Am. Heart J. 143:602-611 (2002), which is hereby incorporated by reference in its entirety) due to the modifications of the methodology as described above. Thus, we propose that this instrument may be useful to measure accurately the level of platelet inhibition at the periprocedural time of an intervention and during the duration of the drug infusion. Our study also demonstrated that the Ultegra® does not have a high correlation to results obtained by either LTA or Plateletworks®. While other studies have suggested that the Ultegra inhibition levels over-estimate that observed with LTA, this is the first study to carry out a systematic evaluation of platelet inhibition across dosing ranges of antagonists and to establish the relationship of platelet inhibition obtain by two currently used point of care devices with the standard LTA. Our data suggest that the results from the Ultegra® will overestimate GPIIb-IIIa antagonist inhibition between 0-95% EPA as measured by LTA. However, if a greater than 95% inhibition is achieved by Ultegra® in samples collected with the PPACK anticoagulant, it is probable that ≧80% inhibition would be measured by either LTA or Plateletworks. Ultegra® values less than 95%, however, cannot be adequately assessed. In conclusion, based on published results using other currently available point of care instruments, the ICHOR/Plateletworks® promises to most closely reflect the results obtained by light transmission aggregometry. Studies are needed to validate this instrument for a point of care monitor for other anti-platelet therapies and for its utility for dose adjustment of patients receiving anti-platelet therapies in the acute and managed care setting.

### Example 2

### Detection of Platelet Microaggregates in Blood Sample

When testing samples containing Reopro, the ICHOR instrument never achieves more than 60% inhibition of aggregation. After evaluation of the platelet histograms obtained simultaneously with the platelet counts obtained in these assays, it was evident from MPV values that microaggregates were being included in the platelet counts. When doublets or triplets are counted as “one” cell this lowers the platelet count and is interpreted as “aggregation.” The microaggregates are too small to be detected by the aggregometer and therefore overestimation of inhibition is observed. This phenomenon of increased MPV's and lower than expected % IPA's is not seen using another antibody based GPIIbIIIa antagonist or any other peptides or peptidomimetics. The described methodology has a greater sensitivity to microaggregates.

If blood was drawn into a standard PPACK tube it could be held until testing occurred. Testing would include addition of 1 ml anticoagulated blood to a test tube containing agonist and the test performed. This would allow for the running of duplicates (should a question of accuracy arise) or for the running of more than one agonist should that test system be introduced in the future.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A method of measuring platelet aggregation in a blood sample comprising:
obtaining a blood sample from an individual;
exposing the blood sample immediately to an anticoagulant;
treating the anticoagulated blood sample with an agonist of platelet aggregation; and
analyzing the treated blood sample with an automated hematology analyzer to determine the degree of platelet aggregation in the treated blood sample, wherein said analyzing is carried out prior to the occurrence of substantial disaggregation.

2. The method according to claim 1 wherein the anticoagulant is D-Phe-Pro-Arg chloromethyl ketone dihydrochloride.

3. The method according to claim 1 wherein the automated hematology analyzer is an electrical impedance-type hematology analyzer.

4. The method according to claim 1 further comprising:
mixing the treated blood sample prior to said analyzing.

5. The method according to claim 4 wherein said mixing is carried out by inversion.

6. The method according to claim 1 wherein the platelet aggregation determined during said analyzing correlates to platelet aggregation as measured by LTA r²≧0.85.

7. The method according to claim 1 wherein said analyzing is carried out within less than about 5 minutes after said treating.

8. The method according to claim 1 wherein said analyzing is carried out within less than about 3 minutes after said treating.

9. The method according to claim 1 wherein said analyzing is carried out substantially immediately after said treating.

10. A method of determining or monitoring the efficacy of anti-platelet therapy comprising:
obtaining a blood sample from an individual treated with an anti-platelet therapy;
exposing the blood sample immediately to an anticoagulant;
treating the anticoagulated blood sample with an agonist of platelet aggregation; and
analyzing the treated blood sample with an automated hematology analyzer to determine the level of platelet aggregation inhibition in the treated blood sample,
wherein platelet count at or above a baseline level indicates that the anti-platelet therapy is less than effective and
wherein said analyzing is carried out prior to the occurrence of substantial disaggregation.

11. The method according to claim 10 wherein the anti-platelet therapy comprises GPIIb-IIIa antagonist therapy.

12. The method according to claim 11 wherein the GPIIb-IIIa antagonist is abciximab, eptifibatide, or tirofiban.

13. The method according to claim 10 wherein the anticoagulant is D-Phe-Pro-Arg chloromethyl ketone dihydrochloride.

14. The method according to claim 10 further comprising:
modifying the anti-platelet therapy administered to the individual and
repeating said obtaining, said exposing, said treating, and said analyzing,
wherein platelet count at or above either the baseline level or the previously determined level indicates that the modified anti-platelet therapy is ineffective.

15. The method according to claim 10 wherein the automated hematology analyzer is an electrical impedance-type hematology analyzer.

16. The method according to claim 10 further comprising:
mixing the anticoagulated blood sample prior to said analyzing.

17. The method according to claim 10 wherein the baseline level is determined by performing said obtaining, said exposing, and said analyzing either prior to or during administration of anti-platelet therapy to an individual.

18. The method according to claim 17 wherein the anticoagulant used in said determining the baseline level is the same anticoagulant used in said exposing.

19. The method according to claim 18 wherein the anticoagulant is D-Phe-Pro-Arg chloromethyl ketone dihydrochloride.

20. The method according to claim 10 wherein said analyzing is carried out substantially immediately after said treating.

21. The method according to claim 10 wherein said analyzing is carried out within about 5 minutes following said treating.

22. The method according to claim 10 wherein said analyzing is carried out within about 3 minutes following said treating.

23. A method of detecting the presence of platelet micro-aggregates in a blood sample comprising:
obtaining a blood sample from an individual;
exposing the blood sample immediately to an anticoagulant;
treating the anticoagulated blood sample with an agonist of platelet aggregation; and
analyzing the treated blood sample with an automated hematology analyzer,
wherein an MPV substantially greater than measured at baseline indicates the presence of platelet aggregates in the test sample and indicative of incomplete inhibition of platelet aggregation.

24. The method according to claim 23 wherein the anticoagulant is D-Phe-Pro-Arg chloromethyl ketone dihydrochloride or sodium-citrate.

25. The method according to claim 23 wherein the automated hematology analyzer is an ICHOR hematology analyzer.

26. The method according to claim 23 further comprising:
mixing the treated blood sample prior to said analyzing.

27. The method according to claim 26 wherein said mixing is carried out by inversion.

28. The method according to claim 23 wherein said analyzing is carried out within about 5 minutes following said treating.

29. The method according to claim 23 wherein said analyzing is carried out within about 3 minutes following said treating.
